(19) United States
(12) Patent Application Publication
(10) Pub. No.: US 2018/0329365 A1
(43) Pub. Date: Nov. 15, 2018

(54) HOLOGRAPHIC DISPLAY DEVICE AND OPERATING METHOD THEREOF

(71) Applicant: BOE TECHNOLOGY GROUP CO., LTD., Beijing (CN)

(72) Inventors: Yuxin Zhang, Beijing (CN); Bingchuan Shi, Beijing (CN); Wei Wei, Beijing (CN)

(73) Assignee: BOE TECHNOLOGY GROUP CO., LTD., Beijing (CN)

(21) Appl. No.: 15/578,569

(22) PCT Filed: Jun. 13, 2017
(86) PCT No.: PCT/CN2017/087998

§ 371 Date: Nov. 30, 2017

(30) Foreign Application Priority Data
Sep. 5, 2016 (CN) 201610802283.0

(51) Int. Cl. G03H 1/22; G03H 1/00

(52) U.S. Cl. CPC G03H 1/2286; G03H 1/2294; G03H 2001/0224; G03H 2001/0088; G03H 1/0005

(57) ABSTRACT

Holographic display device and operation method thereof are provided. A holographic display device includes a light source device including a plurality of, light sources; and an imager including a plurality of imaging regions each corresponding to one light source. The imager includes at least one spatial light modulator configured to receive light from the plurality of light sources to form a plurality of holographic images.

### CROSS-REFERENCE TO RELATED APPLICATION

This PCT patent application claims priority to Chinese Patent Application No. 201610802283.0, filed on Sep. 5, 2016, the entire contents of which are incorporated herein by reference.

### TECHNICAL FIELD

The present disclosure generally relates to the display technologies and, more particularly, to a holographic display device and a method for operating the holographic display device.

### BACKGROUND

Holographic display technology is a display technology that uses interference and diffraction to record and reproduce three-dimensional images of an actual object, and displays information of the object from various angles. Holographic display technology is one solution to realize three-dimensional display.

### SUMMARY

One aspect of present disclosure provides a holographic display device. The holographic display device includes a light source device including a plurality of light sources; and an imager including a plurality of imaging regions each corresponding to one light source. The imager includes at least one spatial light modulator configured to receive light from the plurality of light sources to form a plurality of holographic images.

Optionally, the imaging unit includes a spatial light modulator, and a display of the spatial light modulator is divided into the plurality of imaging regions.

Optionally, the imager includes a plurality of spatial light modulators, a display of each of the spatial light modulators being one of the imaging regions.

Optionally, the spatial light modulator includes a liquid crystal display spatial light modulator.

Optionally, a light-exiting surface of the imager includes a curved surface.

Optionally, the plurality of imaging regions each has a curved surface and the curved surfaces of the imaging regions are arranged tightly to form the light-exiting surface of the imager.

Optionally, the curved surface includes a concave-shaped surface.

Optionally, a light-exiting surface of the imager includes a discrete-bent surface.

Optionally, the plurality of imaging regions each has a flat surface and the flat surfaces of the imaging regions are arranged tightly to form the light-exiting surface of the imager.

Optionally, the holographic display device further includes an eye tracker configured to determine an orientation of a user eye at an observing position. The eye tracker includes one or more of a camera, an eye motion tracker, or an infrared sensor.

Optionally, the holographic display device further includes a controller configured to control one of the light sources and one of the imaging regions that correspond to one holographic image observed by a user eye.

Optionally, the holographic display device further includes an adjuster between the light source device and the imager, and configured to adjust light emitted by the light source device.

Optionally, the adjuster is configured to collimate the light emitted by the light source device and the adjuster includes a plurality of lenses or lens sets.

Optionally, the adjuster is configured to expand and collimate the light emitted the light source device.

Optionally, the adjuster includes a plurality of expanding-collimating lens sets

Optionally, each of the expanding-collimating lens sets includes two lenses having different focal lengths.

Optionally, each of the light sources includes one or more light sources emitting light of at least one color.

Optionally, each of the light sources includes: light sources emitting light of different colors and a semi-reflective minor configured to reflect or transmit light from one of the light sources.

Optionally, the one or more light sources include one or more light-emitting diodes or one or more lasers.

Another aspect of the present disclosure provides a method for operating the disclosed holographic display device, including: determining the orientation of the user eye; and controlling one of the light sources and one of the imaging regions corresponding to the orientation of the user eye to display the holographic image.

### BRIEF DESCRIPTION OF THE FIGURES

The following drawings are merely examples for illustrative purposes according to various disclosed embodiments and are not intended to limit the scope of the present disclosure.

FIG. 1 illustrates an exemplary holographic display device according to various disclosed embodiments of the present disclosure;

FIG. 2 illustrates another exemplary holographic display device according to various disclosed embodiments of the present disclosure;

FIG. 3 illustrates another exemplary holographic display device according to various disclosed embodiments of the present disclosure;

FIG. 4 illustrates an exemplary expanding-collimating lens in an exemplary holographic display device according to various disclosed embodiments of the present disclosure;

FIG. 5 illustrates another exemplary holographic display device according to various disclosed embodiments of the present disclosure;

FIG. 6 illustrates an exemplary light source in an exemplary holographic display device according to various disclosed embodiments of the present disclosure;

FIG. 7 illustrates an exemplary division in an imaging region of an imager in an exemplary holographic display device according to various disclosed embodiments of the present disclosure;

FIG. 8 illustrates an exemplary division in an imaging region of an imager in another exemplary holographic display device according to various disclosed embodiments of the present disclosure; and

FIG. 9 illustrates a block diagram of a controller in an exemplary holographic display device according to various disclosed embodiments of the present disclosure.

### DETAILED DESCRIPTION

Exemplary embodiments of the disclosure will now be described in more detail with reference to the drawings. It is to be noted that the following descriptions of some embodiments are presented herein for purposes of illustration and description only. It is not intended to be exhaustive or to be limiting.

The present disclosure provides a holographic display device, including an imager, a light source device, an eye tracker, and a controller.

The imager may be divided into a plurality of imaging regions. An imaging region may independently form a holographic image.

The light source device may include at least one light source. For example, the light source device may include a plurality of light sources. A light source may correspond to and provide light for an imaging region. The light emitted by the light sources may point to a same observing position after passing through the corresponding imaging regions.

The eye tracker may determine an orientation of a human eye, e.g., a user's eye. The eye tracker may also be referred to as a human eye tracker. The user's eye may be located at the observing position.

The controller may control the light sources and the imaging regions to display a holographic image based on the orientation of the human eye.

In the disclosed holographic display device, the imager may be divided into a plurality of imaging regions. An imaging region may independently form a holographic image, and different imaging, regions may face different directions or have different orientations. Accordingly, light emitted by the light sources, after passing through the corresponding imaging regions, may point to the same observing position, instead of propagating in parallel. Thus, when a user is observing from the observing position, the user may see the holographic images formed by different imaging regions from different directions. Thus, after the eye tracker determines the orientation of the user's eye, the controller may control the light source and the imaging region that correspond to the orientation of the user's eye to display a holographic image. Thus, when the orientation of the user's eye changes in a certain range, the user may still be able to see the holographic image without interruption. The viewing angle range of observation may be expanded and the observation may have a higher degree of freedom.

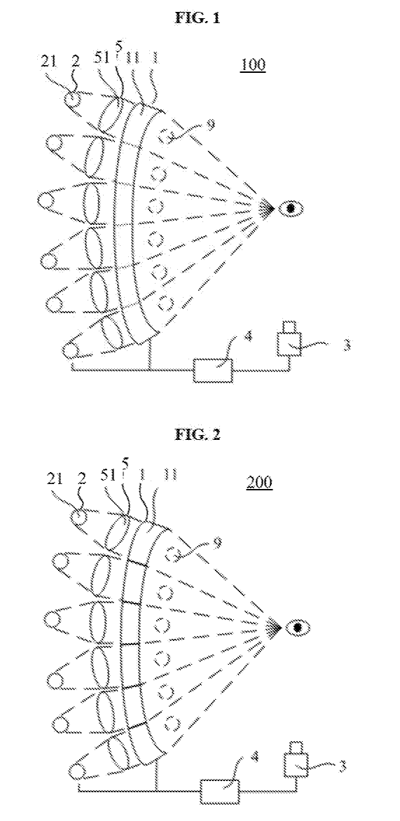

FIG. 1 schematically shows an exemplary holographic display device 100 consistent with the disclosure. The holographic display device 100 includes an imager 1, a light source device 2 including a plurality of light sources 21, an eye tracker 3, and a controller 4.

In some embodiments, a light-exiting surface of the imager 1, i.e., the surface of the imager 1 that faces away from the light source device, may be a curved surface. In some embodiments, the light-exiting surface of the imager 1 may be a concave-shaped surface. In some embodiments, the light-exiting surface of the imager 1 may be a smooth and continuous curved surface.

The light-exiting surface of the imager 1 is divided into a plurality of imaging regions 11. Each of the imaging regions 11 can project a holographic image 9. By changing the shape or curvature of the light-exiting surface, the light-exiting directions of the light emitted from the imaging regions 11 can be changed. To ensure the light emitted by different imaging regions 11 points to the same observing position, the light-exiting surface can be, for example, a concave-shaped curved surface, such as a part of a sphere surface. Accordingly, the observing position may be located at a concave side of the curved surface. For example, the observing position may be located at, or substantially at, a sphere center corresponding to the sphere surface.

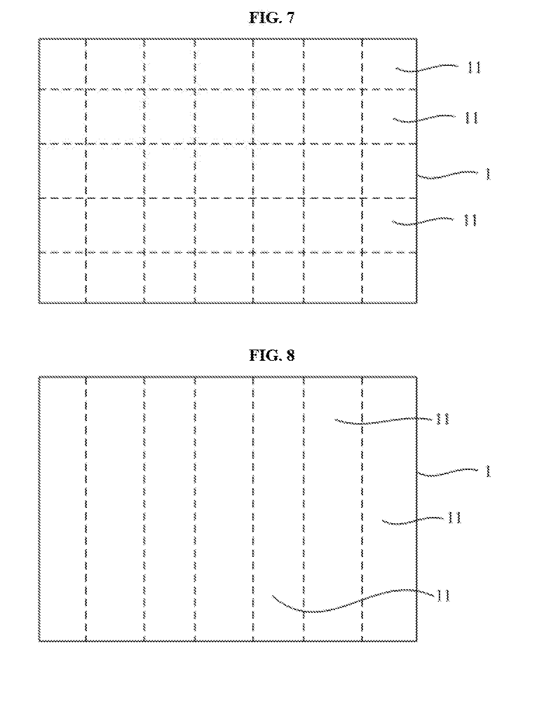

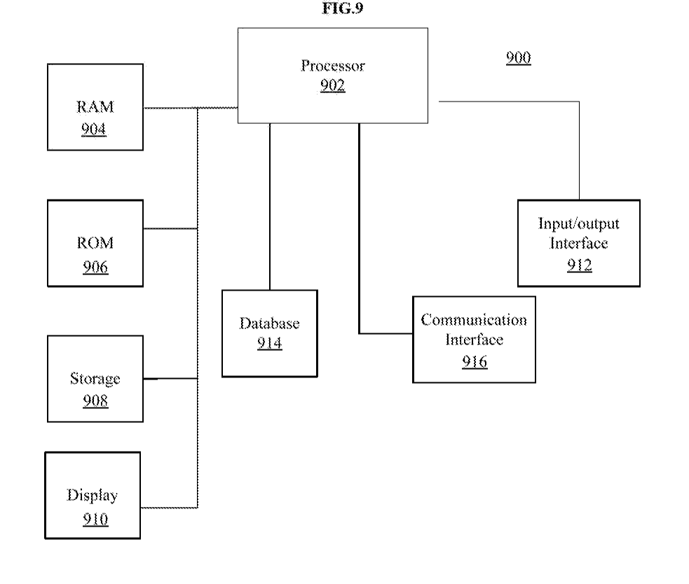

The light-exiting surface of the imager 1 may be divided into the imaging regions 11 in many different ways. For example, the light-exiting surface may be divided into a plurality of blocks in a grid, as shown in FIG. 7, or may be divided into a plurality of strips, as shown in FIG. 8. The specific way to divide the light-exiting surface may be chosen according to different applications and/or designs and should not be limited by the exemplary embodiments of the present disclosure.

In some embodiments, as shown in FIG. 1, the imager 1 includes a spatial light modulator (SLM) divided into a plurality of regions that can be controlled independently. One region of the SLM may receive light emitted by a corresponding light source 21 and independently form a corresponding holographic image 9. That is, as shown in FIG. 1, one region of the SLM constitutes one imaging region 11. Since the imaging regions 11 are regions on the same SLM, there is no space or distance between two adjacent imaging regions 11, and the imaging regions 11 are tightly arranged, or connected together. Thus, it is easier to form a continuous viewing angle.

The imager 1 is not limited to that shown in FIG. 1, and can have a different structure. For example, FIG. 2 schematically shows another exemplary holographic display device 200 consistent with the disclosure. The holographic display device 200 is similar to the holographic display device 100, except that in the holographic display device 200, the imager 1 includes a plurality of SLMs, each of which constitutes an imaging region 11. The plurality of SLMs may be arranged together according to a predetermined arrangement/configuration, to form the imager 1. Thus, the SLMs are separate from and independent of each other. It is easier to control the SLMs and the light-exiting ranges of different SLMs may be easier to distinguish.

In some embodiments, the SLMs have curved surfaces and are arranged together tightly such that no space is formed between adjacent SLMs. The curved surfaces of the SLMs together form a curved surface as the light-exiting surface of the imager 1, as shown in FIG. 2.

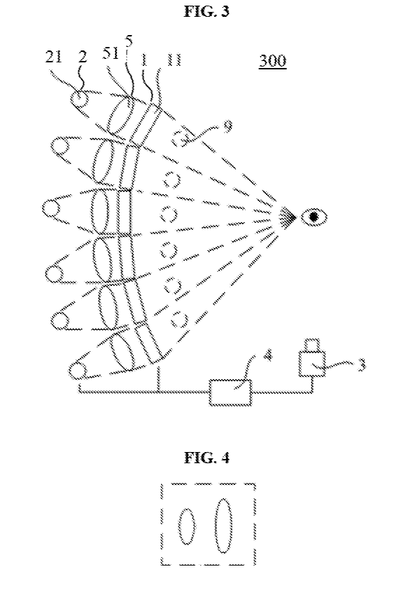

In various embodiments of the present disclosure, the SLMs may also have other shapes and may be arranged in other different ways. The different arrangement of the SLMs may also enable the light to be emitted from the imaging regions 11 and point to the same observing position. For example, FIG. 3 schematically shows another exemplary holographic display device 300 consistent with the disclosure. The holographic display device 300 is similar to the holographic display device 200, and the imager 1 in the holographic display device 300 also includes a plurality of SLMs. However, in the holographic display device 300, the light-exiting surfaces of the SLMs include flat surfaces. The flat light-exiting surfaces of the SLMs together form a discrete-bent surface, which constitutes the light-exiting surface of the imager 1 of the holographic display device 300, as shown in FIG. 3.

In a holographic display device having multiple SLMs in the imager 1, such as the holographic display device 200 or the holographic display device 300 described above, the SLMs can be arranged together tightly without space between neighboring SLMs, as shown in FIGS. 2 and 3. In some other embodiments, neighboring SLMs can be separated by a certain distance, i.e., the SLMs are not arranged tightly together.

In some embodiments, the SLMs described above may be liquid crystal display SLMs (LCD-SLMs).

In some embodiments, the holographic display device consistent with the disclosure, such as one of the exemplary holographic display devices 100, 200, and 300 described above, further includes an adjuster 5 arranged between the light source device 2 and the imager 1, as shown in FIGS. 1-3. The adjuster 5 includes a plurality of light-adjusting modules 51 corresponding to the light sources 21 and the imaging regions 11. In some embodiments, as shown in FIGS. 1-3, each, of the light-adjusting modules 51 corresponds to one of the light sources 21 and one of the imaging regions 11, and is configured to adjust the light emitted by the corresponding light source 21 and project the adjusted light to the corresponding imaging region 11.

The light-adjusting module 51 can include any suitable optical device that can adjust the light emitted by the corresponding light source 21 as needed. For example, the imager 1, formed by, e.g., one or more SLMs, may require collimated light to realize holographic display. Thus, the light-adjusting module 51 can include a lens, such as a convex lens, or a lens set including a plurality of lenses, for collimating the light emitted by the corresponding light source 21. In some other embodiments, the light-adjusting module 51 can include an expanding-collimating lens set for expanding and collimating the light emitted by the corresponding light source 21. FIG. 4 schematically shows an exemplary expanding-collimating lens set consistent with the disclosure. The expanding-collimating lens set shown in FIG. 4 includes a pair of convex lenses having different focal lengths, with the lens having a shorter focal length arranged closer to the corresponding light source 21. In some other embodiments, the expanding-collimating lens set can include a concave lens and a convex lens, with the concave lens arranged closer to the corresponding light source 21.

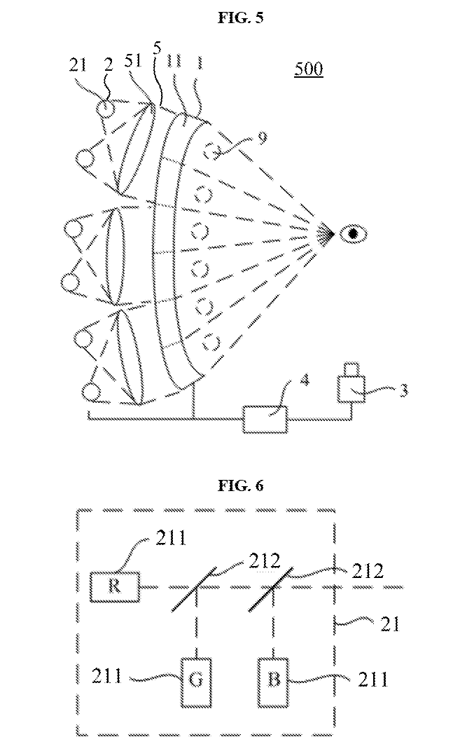

In the examples shown in FIGS. 1-3, one light-adjusting module 51 corresponds to one light source 21 and one imaging region 11. In some embodiments, the directions of light emitted by different light sources 21 are substantially the same and thus two or more light sources 21 can share a same light-adjusting module 51. FIG. 5 schematically shows another exemplary holographic display device 500 consistent with the disclosure. The holographic display device 500 is similar to the holographic display device 100, except that in the holographic display device 500, one light-adjusting module 51 corresponds to a plurality of neighboring light sources 21, or to as plurality of neighboring imaging regions 11, or to both a plurality of neighboring light sources 21 and a plurality of neighboring imaging regions 11. In some embodiments, the imager 1 in the holographic display device 500 can have a same or similar structure as the imager 1 in the holographic display device 200 or 300.

According to the disclosure, the light source 21 may include one or more light sources. For example, the light source 21 may include one or more light sources of the same color to form single-color holographic images 9. As another example, the light source 21 may include a plurality of light sources of different colors to form multi-color holographic images 9. Each light source can be, for example, a light emitting diode (LED) or a laser.

FIG. 6 schematically shows an exemplary light source 21 consistent with the disclosure. The light source 21 shown in FIG. 6 includes a plurality of light sources 211 pointing in different directions and a plurality of semi-reflective mirrors 212. The light emitted by one light source 211 may pass through one or more semi-reflective mirrors 212, or be reflected by one or more semi-reflective mirrors 212, or pass through one or more semi-reflective mirrors 212 and be reflected by one or more semi-reflective mirrors 212, and then exit the light source 21 along a light-exiting direction of the light source 2.

For example, as shown in FIG. 6, the light sources 211 in the light source 212 includes a red light source 211 that emits red light and is marked “R” in the figure, a green light source 211 that emits green light and is marked in the figure, and a blue light source 211 that emits blue light and is marked “B” in the figure. The red light emitted by the red light source 211 passes both semi-reflective minor 212 and leaves the light source 21 along the light-exiting direction. The green light emitted by the green light source 211 is reflected by one semi-reflective mirror 212 and passes through the other semi-reflective minor 212, and then leaves the light source 21 along the light-exiting direction. The blue light emitted by the blue light source 211 is reflected by one semi-reflective mirror 212 and leaves the light source 21 along the light-exiting direction. In some embodiments, the light from different light sources 212 exists the light source 21 from a same position or close positions of the light source 21.

In some other embodiments, the light source 21 may have a different structure. For example, the number of light sources 211 that emit light of the same color may be more than one. In another example, the light source 21 may not include the semi-reflective mirror 212, and the plurality of light sources 211, such as light sources 211 emitting light of different colors, may be arranged close to each other, so that light from different light sources 211 can be emitted by the light source 21 from a same position or close positions.

Referring again to any one of FIGS. 1-3 and 5, the eye tracker 3 points to the observing position and is configured to determine an orientation of a user's eye. In some embodiments, the eye tracker 3 may include one or more of a camera, an eye motion tracker, or an infrared sensor. The eye tracker 3 may also include other usable devices capable of tracking the movement of an eye. The camera may collect images, and analyze the collected images to locate a human eye and determine the orientation of the human eye. The eye motion tracker may directly track the orientation of a human eye. The infrared sensor may determine the orientation of a human eye based on the infrared light emitted by the human eye.

As shown in FIGS. 1-3 and 5, the controller 4 is coupled to the light source device 2 and the imager 1, and is configured to control the light sources 21 and the imaging regions 11 based on the orientation of the user's eye determined by the eye tracker 3, to display holographic images. That is, the controller 4 may control the light sources 21 and the imaging regions 11 in the orientation direction of the user's eye to display holographic images. Thus, when the orientation of the user's eye changes in a certain range, the user may still be able to see the holographic images. The viewing angle range of observation may be expanded, and the observation may have a higher degree of freedom.

The present disclosure also provides a method to display or operate a holographic display device. The holographic display device may be a holographic display device consistent with the disclosure, such as one of the above-described exemplary holographic display devices. The method to display a holographic display device may include determining the orientation of the user's eye through an eye tracker. The method may further include controlling, through a controller, light sources and imaging regions facing the user's eye to display holographic images.

That is, when using the disclose holographic display device to display holographic images, the eye tracker may be used to keep tracking the orientation of the user's eye, and the controller may be used to control the light sources and imaging regions facing the user's eye to display holographic images. Thus, when the orientation of the user's eye changes within a certain range, the user may still be able to see the holographic images. The viewing angle range of observation may be expanded, and the observation may have a higher degree of freedom.

The imager of the disclosed holographic display device can be divided into a plurality of imaging regions each of which can independently form holographic images. The light emitted by the light sources may point to the observing position after passing through the corresponding imaging regions. Thus, at the observing position, the user may see holographic images formed by different imaging regions, along different directions.

FIG. 9 illustrates a block diagram of a controller 900 consistent with the present disclosure, such as the controller 4 in the exemplary embodiments illustrated in FIGS. 1-3 and 5.

The controller 900 may receive, process, and execute commands from the holographic display device. The controller 900 may include any appropriately configured computer system. As shown in FIG. 9, controller 900 includes one or more of a processor 902, a random access memory (RAM) 904, a read-only memory (ROM) 906, a storage 908, a display 910, an input/output interface 912, a database 914, and a communication interface 916. Other components may be added and certain components may be removed without departing from the principles of the disclosed embodiments.

The processor 902 may include any appropriate type of general purpose microprocessor, digital signal processor or microcontroller, and application specific integrated circuit (ASIC). The processor 902 may execute sequences of computer program instructions to perform various processes associated with the controller 900. Computer program instructions may be loaded into the RAM 904 for execution by the processor 902 from the read-only memory 906, or from the storage 908. The storage 908 may include any appropriate type of mass storage provided to store any type of information that the processor 902 may need to perform the processes. For example, the storage 908 may include one or more hard disk devices, optical disk devices, flash disks, or other storage devices to provide storage space.

The display 910 may provide information to a user or users of the controller 900. The display 910 may include any appropriate type of computer display device or electronic device display (e.g., CRT or LCD based devices). The input/output interface 912 may be provided for users to input information into the controller 900 or for the users to receive information from the controller 900. For example, the input/output interface 912 may include any appropriate input device, such as a keyboard, a mouse, an electronic tablet, voice communication devices, touch screens, or any other optical or wireless input devices. Further, the input/output interface 912 may receive from and/or send to other external devices.

Further, the database 914 may include any type of commercial or customized database, and may also include analysis tools for analyzing the information in the databases. The database 914 may be used for storing data for image processing and calculation. The communication interface 916 may provide communication connections such that the controller 900 may be accessed remotely and/or communicate with other systems through computer networks or other communication networks via various communication protocols, such as transmission control protocol/internet protocol (TCP/IP), hypertext transfer protocol (HTTP), etc.

In some embodiments, the controller 900 may receive data from the eye tracker 3 and perform certain calculation to determine the orientation of the user's eye. Such calculation may include, e.g., image recognition and/or target tracking, and the related parameters and data may be stored in the storage 908 and/or the database 914. Based on the orientation of the user's eye, the controller 900 may control the light sources and the imaging regions corresponding to the orientation of the user's eye to display holographic images such that the user may see holographic images from a desired direction. In some embodiments, the user may control and monitor the display of holographic images through the display 910. For example, the display 910 may show the number and/or location of the imaging regions that are displaying the holographic images. The user may also be able to select desired light sources and imaging regions to display from the input/output interface 912.

The foregoing description of the embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to persons skilled in this art. The embodiments are chosen and described in order to explain the principles of the technology, with various modifications suitable to the particular use or implementation contemplated. It is intended that the scope of the invention be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to exemplary embodiments of the disclosure does not imply a limitation. In the invention, and no such limitation is to be inferred. Moreover, the claims may refer to “first”, “second”, etc. followed by a noun or element. Such terms should be understood as a nomenclature and should not be construed as giving the limitation on the number of the elements modified by such nomenclature unless specific number has been given. Any advantages and benefits described may or may not apply to all embodiments of the disclosure. It should be appreciated that variations may be made to the embodiments described by persons skilled in the art without departing from the scope of the present disclosure. Moreover, no element or component in the present disclosure is intended to be dedicated to the public regardless of whether the element or component is explicitly recited in the following claims.

1. A holographic display device, comprising:
a light source device including a plurality of light sources; and
an imager including a plurality of imaging regions each corresponding to one light source, wherein the imager includes at least one spatial light modulator configured to receive light from the plurality of light sources to form a plurality of holographic images.

2. The holographic display device according to claim 1, wherein the imaging unit includes a spatial light modulator, and a display of the spatial light modulator is divided into the plurality of imaging regions.

3. The holographic display device according to claim 1, wherein the imager includes a plurality of spatial light modulators, a display of each of the spatial light modulators being one of the imaging regions.

4. The holographic display device according to claim 1, wherein the spatial light modulator includes a liquid crystal display spatial light modulator.

5. The holographic display device according to claim 1, wherein a light-exiting surface of the imager includes a curved surface.

6. The holographic display device according to claim 1, wherein the plurality of imaging regions each has a curved surface and the curved surfaces of the imaging regions are arranged tightly to form the light-exiting surface of the imager.

7. The holographic display device according to claim 5, wherein the curved surface includes a concave-shaped surface.

8. The holographic display device according to claim 1, wherein a light-exiting surface of the imager includes a discrete-bent surface.

9. The holographic display device according to claim 8, wherein the plurality of imaging regions each has a flat surface and the flat surfaces of the imaging regions are arranged tightly to form the light-exiting surface of the imager.

10. The holographic display device according to claim 1, further comprising: an eye tracker configured to determine an orientation of a user eye at an observing position, wherein the eye tracker includes one or more of a camera, an eye motion tracker, or an infrared sensor.

11. The holographic display device according to claim 1, further comprising: a controller configured to control one of the light sources and one of the imaging regions that correspond to one holographic image observed by a user eye.

12. The holographic display device according to claim 1, further comprising: an adjuster between the light source device and the imager, and configured to adjust light emitted by the light source device.

13. The holographic display device according to claim 12, wherein the adjuster is configured to collimate the light emitted by the light source device and the adjuster includes a plurality of lenses or lens sets.

14. The holographic display device according to claim 12, wherein the adjuster is configured to expand and collimate the light emitted by the light source device.

15. The holographic display device according to claim 14, wherein the adjuster includes a plurality of expanding-collimating lens sets.

16. The holographic display device according to claim 15, wherein each of the expanding-collimating lens sets includes two lenses having different focal lengths.

17. The holographic display device according to claim 1, wherein each of the light sources includes one or more light sources emitting light of at least one color.

18. The holographic display device according to claim 17, wherein each of the light sources includes: light sources emitting light of different colors and a semi-reflective mirror configured to reflect or transmit light from one of the light sources.

19. The holographic display device according to claim 17, wherein the one or more light sources include one or more light-emitting diodes or one or more lasers.

20. A method for operating the holographic display device according to claim 1, comprising:
determining the orientation of the user eye; and
controlling one of the light sources and one of the imaging regions corresponding to the orientation of the user eye to display the holographic image.
